(19) United States
(12) Patent Application Publication
(10) Pub. No.: US 2003/0147008 A1
(43) Pub. Date: Aug. 7, 2003

(54) Tablet personal computer capable of switching devices for displaying output and receving input

(76) Inventor: Jefferson Liu, Taichung (TW)

Correspondence Address: PRO-TECHTOR INTERNATIOAL, 20775 Norada Court, Saratoga, CA, 95070-3018, US

(21) Appl. No.: 10/358,506

(22) Filed: Feb. 4, 2003

(30) Foreign Application Priority Data
Feb. 7, 2002 (TW) 091201491

(51) Int. Cl. H04N 7/00; H04N 11/00

(52) U.S. Cl. 348/552

(57) ABSTRACT

A tablet personal computer capable of switching devices for displaying output and receiving input comprising a touch LCD monitor, a motherboard and an input connector. The touch LCD monitor has a function of receiving input from an electronic pen. The motherboard is electrically connected to the touch LCD monitor and contains at least a central processing unit (CPU) and a built-in radio receiver; the radio receiver is for receiving signals from an indefinite wireless input device. The input connector is for connecting an indefinite wired input device. A tablet personal computer according to the present invention further includes an output display switch for switching output display to an indefinite external monitor. The output display switch is connected to a wireless audio-video transmitter for transmitting the contents of the CPU operation to an external wireless audio-video receiver; the wireless audio-video receiver is connected to an external monitor.

### FIELD OF THE INVENTION

The present invention relates to a tablet personal computer, more particularly to a tablet personal computer capable of switching devices for displaying output and receiving input.

### BACKGROUND OF THE INVENTION

As shown in FIG. 1, a conventional tablet personal computer 10 comprises a touch LCD monitor 103 capable of receiving input from an electronic pen 101 and a motherboard 105 electrically connected to the touch LCD monitor 103. Although a conventional tablet personal computer 10 is easy to carry, its usage is substantially constrained by its small size. For example, the monitor attached to a conventional tablet personal computer 10 is usually small; the input means of an electronic pen 101 is not convenient for a large quantity of input information. The conventional tablet personal computer 10 does not have the convenience of easy connection to a desktop computer.

### SUMMARY OF THE INVENTION

Accordingly, the primary object of the present invention is to provide a tablet personal computer capable of freely choosing input devices and monitors, so that the advantages of a desktop computer and a conventional tablet personal computer are integrated therein.

To achieve above objects, the present invention provides a tablet personal computer capable of switching devices for displaying output and receiving input comprising a touch LCD monitor, a motherboard and an input connector. The touch LCD monitor has a function of receiving input from an electronic pen. The motherboard is electrically connected to the touch LCD monitor and contains at least a central processing unit (CPU) and a built-in radio receiver; the radio receiver is for receiving signals from an indefinite wireless input device. The input connector is for connecting an indefinite wired input device. A tablet personal computer according to the present invention further includes an output display switch for switching output display to an indefinite external monitor. The output display switch is connected to a wireless audio-video transmitter for transmitting the contents of the CPU operation to an external wireless audio-video receiver; the wireless audio-video receiver is connected to an external monitor. The output display switch may further switch the touch LCD monitor to an energy-saving mode when an external monitor is in use.

The various objects and advantages of the present invention will be more readily understood from the following detailed description when read in conjunction with the appended drawings.

### BRIEF DESCRIPTION OF THE DRAWINGS

FIG. 1 is a diagram of a conventional tablet personal computer.

FIG. 2 shows the outlook of the present invention of a tablet personal computer.

FIG. 3, is the block diagram illustrating the tablet personal computer of FIG. 2.

FIG. 4 is the first diagram showing the tablet personal computer in operation with an input device.

FIG. 5 is the second diagram showing the tablet personal computer in operation with an input device.

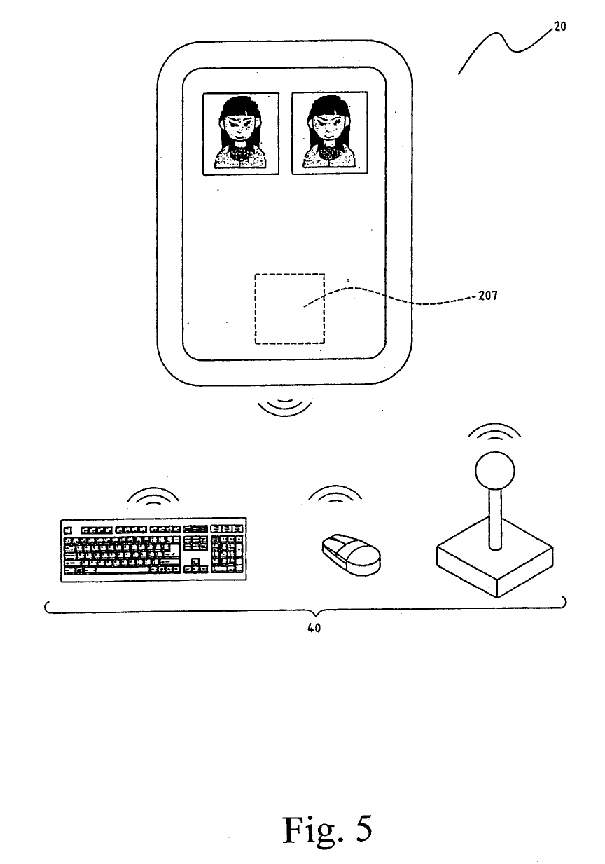

FIG. 6 shows the tablet personal computer in operation with a large-scaled monitor.

### DETAILED DESCRIPTION OF THE PREFERRED EMBODIMENTS

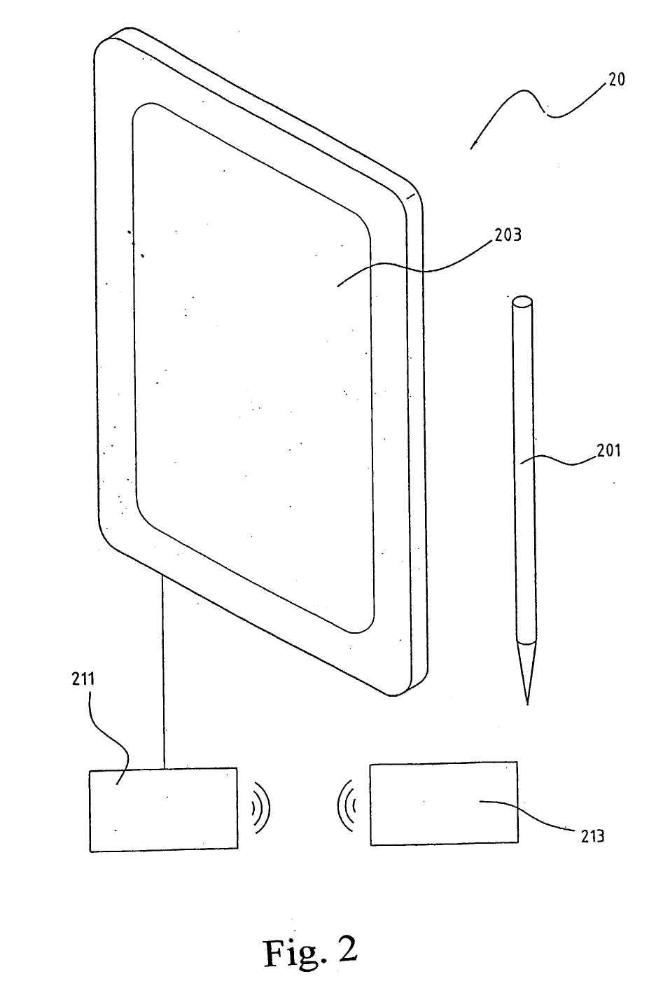

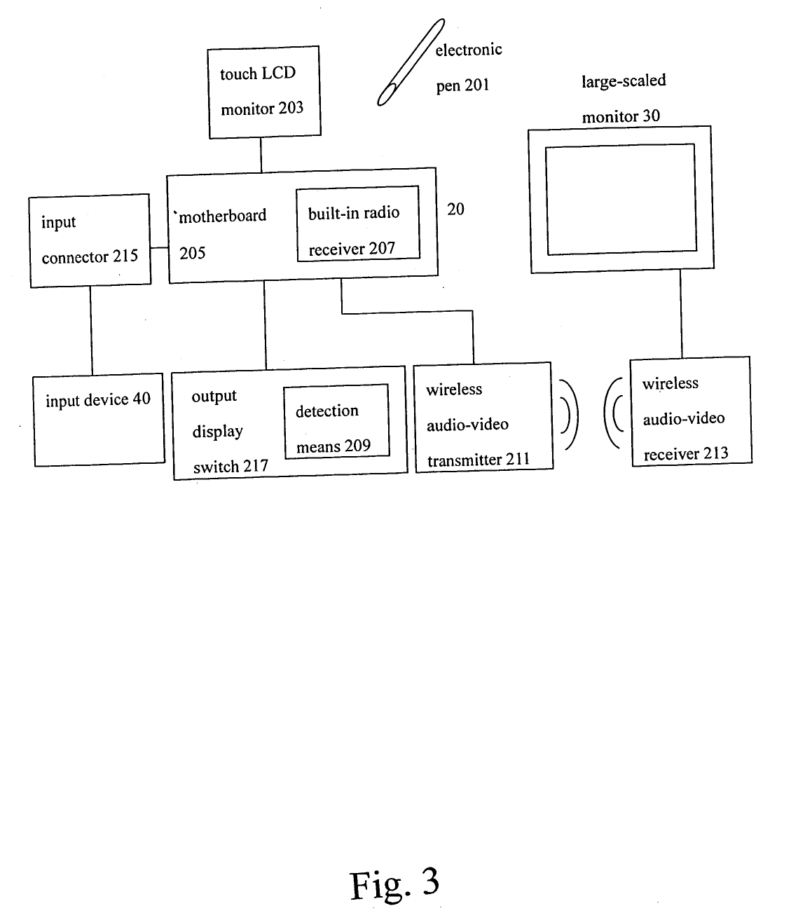

FIG. 2 shows the outlook of the present invention of a tablet personal computer. FIG. 3 is the associated block diagram illustrating the system structure of the tablet personal computer shown in FIG. 2. A tablet personal computer 20 comprises an electronic pen 201, a touch LCD monitor 203, and a motherboard 205 that is electrically connected to the touch LCD monitor 203. The motherboard 205 comprises at least a central processing unit (CPU) and a built-in radio receiver 207 for receiving radio signals from a wireless input device. The motherboard 205 further contains an input connector 215 for connecting a wired input device 40. The present invention further includes an output display switch 217 that is connected to a wireless audio-video transmitter 211 for transmitting the image on the touch LCD monitor 203, which indicates the operation of the CPU, to a wireless audio-video receiver 213. It is a further function that when the output display switch 217 is functioning, the touch LCD monitor 203 can be switched to an energy-saving mode of not displaying for saving electricity.

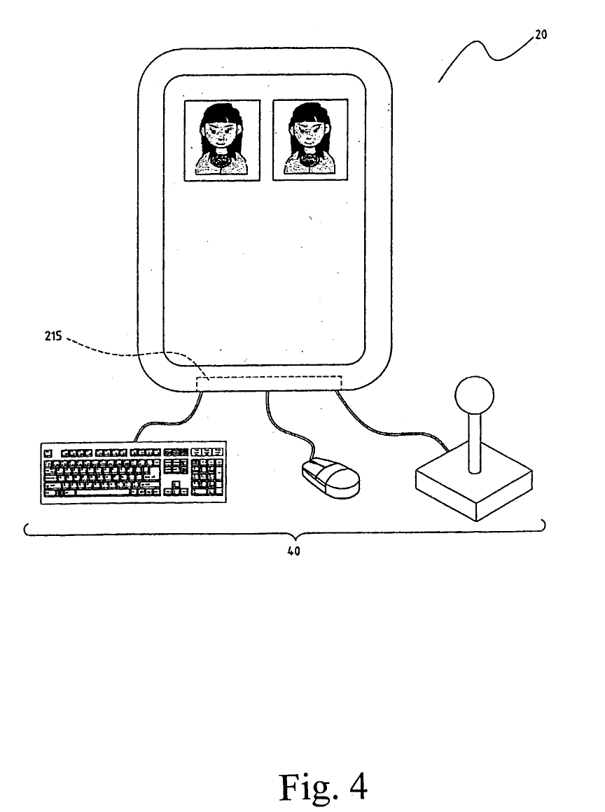

FIG. 4 is the first diagram indicating the operation of a tablet personal computer connected to an input device. The wired input device 40 of FIG. 4 can be a conventional wired keyboard, a wired mouse, a wired joystick, or a wired touch tablet. The input connector 215 coupled with the input device 40 can be a conventional port such as IEEE1394, USB, or PS2.

FIG. 4 is the second diagram indicating the operation of a tablet personal computer connected to an input device. The built-in radio receiver 207 of the motherboard 205 can receive radio signals from a wireless input device such as a wireless keyboard, a wireless mouse, a wireless joystick, or a wireless touch tablet.

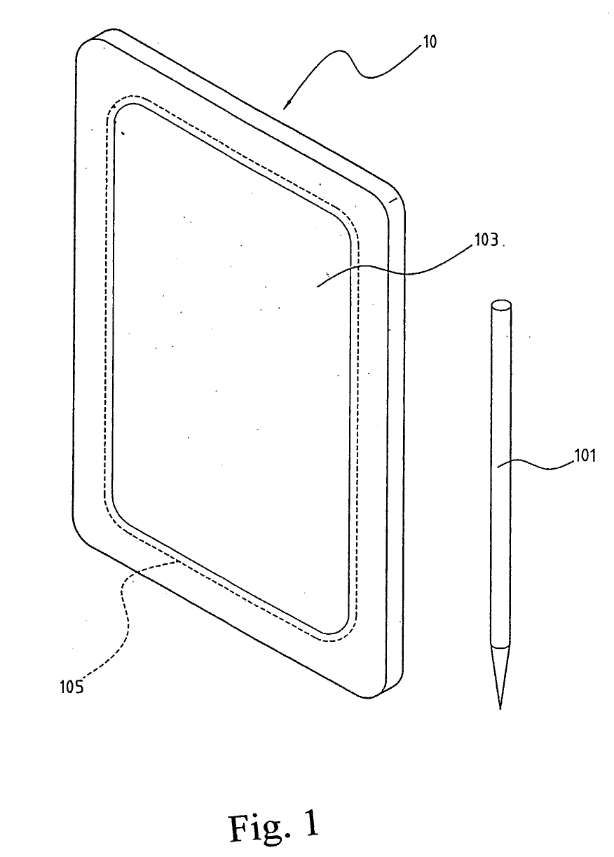

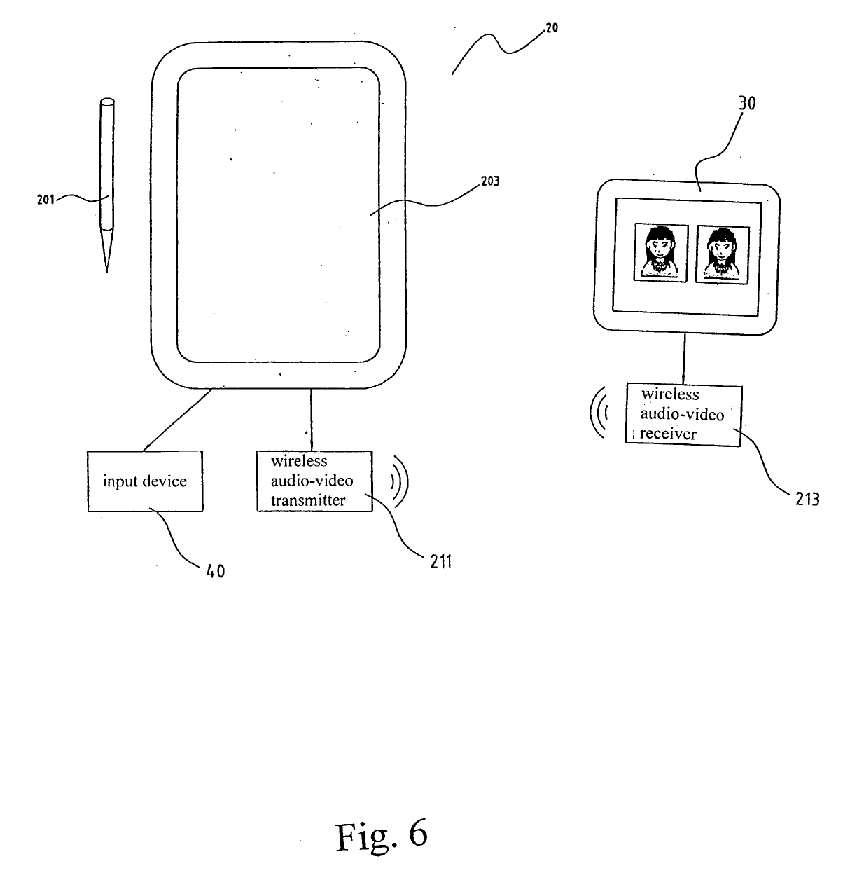

FIG. 6 is a diagram indicating a tablet personal computer connected a large-scaled monitor. As a switching command is sent from a wireless input device via the built-in radio receiver 207 or an input device 40 via the input connector 215 to the tablet personal computer 20, the output display switch 217 functions and the contents of the CPU operation are transmitted by the wireless audio-video transmitter 211 to the wireless audio-video receiver 213 for displaying the contents on a large-scaled monitor 30. The wireless audio-video transmitter 211 of the present invention is separable from the main body of the tablet personal computer 20. The usage of the tablet personal computer 20 when the wireless audio-video transmitter 211 is separated is the same as a conventional tablet personal computer 10 as shown in FIG. 1. That is, the tablet personal computer 20 includes the known functions of a conventional tablet personal computer.

The embodied configuration of the output display switch 217 of the present invention consists of a connector of VGA Dsub-9, DVI-I, or DVI-D; the connector is for connecting the wireless audio-video transmitter 211 of the output display switch 217. The output display switch 217 further consists of a detection means 209 for detecting if the connector is functioning; as long as the detection means 209 detects electric signals channeling between the wireless audio-video transmitter 211 and the connector, it sends message to the motherboard 205 so as to shut off the touch LCD monitor 203 for saving electricity.

The large-scaled monitor 30 working with the present invention can be a television set, a cathode-ray-tube (CRT) monitor, or a monitor of any other kind.

The present invention of a tablet personal computer 20 has the following effects and advantages:

1. As a user selects the function of the output display switch 217 to operate, the touch LCD monitor 203 is shut off for saving electricity. Meanwhile, the displaying function of the touch LCD monitor 203 is taken over by an external large-scaled monitor 30 by transmitting the information for display from the wireless audio-video transmitter 211 to the wireless audio-video receiver 213. Further, the tablet personal computer can be operated using an input device 40, in addition to the electronic pen 10.

2. The present invention of a tablet personal computer 20 extends the function of a conventional tablet personal computer 10 in that a conventional keyboard 40, capable of inputting more efficiently, may replace the input means of an electronic pen 201.

The present invention is thus described by the above embodiments. It will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A tablet personal computer capable of switching devices for displaying output and receiving input comprising
a touch LCD monitor having a function of receiving input from an electronic pen,
a motherboard electrically connected to the touch LCD monitor having at least a central processing unit (CPU) and a built-in radio receiver; the built-in radio receiver receiving signals from an indefinite wireless input device, and an input connector for connecting an indefinite wired input device.

2. The tablet personal computer of claim 1 wherein said wireless audio-video receiver is connected to a large-scaled monitor.

3. The tablet personal computer of claim 2 wherein said large-scaled monitor is a television set.

4. The tablet personal computer of claim 2 wherein said large-scaled monitor is a cathode-ray-tube (CRT) monitor or a monitor of any other kind.

5. The tablet personal computer of claim 1 wherein said wired input device is a conventional keyboard.

6. The tablet personal computer of claim 1 wherein said wired input device is a wired joystick.

7. The tablet personal computer of claim 1 wherein said wired input device is a wired touch tablet or a wired mouse.

8. The tablet personal computer of claim 1 wherein said wireless input device is a wireless keyboard.

9. The tablet personal computer of claim 1 wherein said wireless input device is a wireless joystick.

10. The tablet personal computer of claim 1 wherein said wireless input device is a wireless touch tablet or a wireless mouse.

11. The tablet personal computer of claim 1 wherein said input connector is an IEEE1394 port.

12. The tablet personal computer of claim 1 wherein said input connector is a USB port.

13. The tablet personal computer of claim 1 wherein said input connector is a PS2 port.

14. A tablet personal computer capable of switching devices for displaying output and receiving input comprising
a touch LCD monitor having a function of receiving input from an electronic pen,
a motherboard electrically connected to the touch LCD monitor having at least a central processing unit (CPU) and a built-in radio receiver; the built-in radio receiver receiving signals from an indefinite wireless input device,
an input connector for connecting an indefinite wired input device, and
an output display switch for switching output display to an external monitor; said output display switch being connected to a wireless audio-video transmitter for transmitting the contents of the operation of said CPU to an external wireless audio-video receiver; said wireless audio-video receiver being connected to said external monitor; said output display switch being capable of switching said touch LCD monitor to an energy-saving mode when said external monitor is in use; said output display switch being activated as a switching command is sent from a wireless input device via said built-in radio receiver or from a wired input device via said input connector to said tablet personal computer.

15. The tablet personal computer of claim 14 wherein said wireless audio-video receiver is connected to a large-scaled monitor

16. The tablet personal computer of claim 15 wherein said large-scaled monitor is a television set.

17. The tablet personal computer of claim 15 wherein said large-scaled monitor is a cathode-ray-tube (CRT) monitor or a monitor of any other kind.

18. The tablet personal computer of claim 14 wherein said wired input device is a conventional keyboard.

19. The tablet personal computer of claim 14 wherein said wired input device is a wired joystick.

20. The tablet personal computer of claim 14 wherein said wired input device is a wired touch tablet or a wired mouse.

21. The tablet personal computer of claim 14 wherein said wireless input device is a wireless keyboard.

22. The tablet personal computer of claim 14 wherein said wireless input device is a wireless joystick.

23. The tablet personal computer of claim 14 wherein said wireless input device is a wireless touch tablet or a wireless mouse.

24. The tablet personal computer of claim 14 wherein said input connector is an IEEE1394 port.

25. The tablet personal computer of claim 14 wherein said input connector is a USB port.

26. The tablet personal computer of claim 14 wherein said input connector is a PS2 port.

27. The tablet personal computer of claim 14 wherein said output display switch is also for shutting off said touch LCD monitor so as to carry out an energy-saving mode.
